(19) United States
(12) Patent Application Publication
(10) Pub. No.: US 2009/0033146 A1
(43) Pub. Date: Feb. 5, 2009

(54) METHOD AND DEVICE FOR OPERATING A HYDRAULIC VEHICLE BRAKE SYSTEM

(76) Inventors: Peter Rieth, Eltville (DE); Lothar Schiel, Hofheim (DE); Stefan Drumm, Saulheim (DE)

Correspondence Address: CONTINENTAL TEVES, INC., ONE CONTINENTAL DRIVE, AUBURN HILLLS, MI, 48326-1581, US

(21) Appl. No.: 12/063,778

(22) PCT Filed: Aug. 11, 2006
(86) PCT No.: PCT/EP06/65273

§ 371 Date: Feb. 14, 2008

(30) Foreign Application Priority Data
Aug. 15, 2005 (DE) 10 2005 038 714.4
May 16, 2006 (DE) 10 2006 022 734.4

(51) Int. Cl. B60T 8/40; G06F 17/00

(52) U.S. Cl. 303/116.1; 701/71

(57) ABSTRACT

Disclosed is a method for operating a hydraulic vehicle brake system, having a brake pressure generator operable by a brake actuating device and essentially consisting of a master brake cylinder and a hydraulic booster connected upstream thereof which includes a booster chamber and a booster piston arranged therein, which latter for brake force boosting purposes, can be acted upon by a hydraulic pressure of a high-pressure accumulator that is chargeable by a hydraulic pump according to a sensor system which detects actuation and/or according to a pressure sensor sensing the hydraulic pressure that prevails in the master brake cylinder. In order to provide a safe fallback mode, upon failure of the high-pressure accumulator, the wheel brakes are acted upon by hydraulic pressure of the hydraulic pump according to the sensor system which detects actuation or according to the pressure sensor. Likewise, provisions are made that upon failure of the pump, hydraulic pressure out of the high-pressure accumulator is applied to the booster chamber according to the sensor system which detects actuation or according to the pressure sensor.

The present invention relates to a method for operating a hydraulic vehicle brake system, comprising a brake pressure generator being operable by a brake actuating device and being connectable to wheel brakes of the vehicle by way of a hydraulic line, in which case the brake pressure generator is generally composed of a master brake cylinder and a hydraulic booster connected upstream thereof which includes a booster chamber and a booster piston arranged therein, which latter is operatively connected to a master brake cylinder piston by way of an actuating element in the direction of force output and which, for brake force boosting purposes, can be acted upon by a hydraulic pressure of a high-pressure accumulator that is chargeable by a hydraulic pump according to a sensor system which detects actuation and/or according to a pressure sensor sensing the hydraulic pressure that prevails in the master brake cylinder. Furthermore, the invention relates to a device for implementing the method.

A sufficient rate of vacuum supply for a conventional vacuum brake booster for brake force assistance purposes has become rarer in new engine technology such as Diesel engines or gasoline direct injection engines. This is the reason for development of hydraulic brake systems with active hydraulic brake force assistance. DE 102 44 375 A1 discloses a hydraulic brake system of this type. In the prior art hydraulic vehicle brake system a manually operable brake pressure generator is provided which can be connected to wheel brakes of the vehicle by way of a hydraulic line and which consists of a master brake cylinder and a hydraulic booster connected upstream thereof. The hydraulic booster is connected to a pressure fluid supply tank and includes a booster chamber that is arranged coaxially to the master brake cylinder and a booster piston arranged therein. Hydraulic pressure of an external pressure source is applied to the booster chamber for brake force boosting purposes.

Upon failure of a partial system, an emergency brake function is also expected from this prior art brake system, allowing the operator to perform at least a brake operation with brake force assistance in order to stop the vehicle. Of course, ‘multiple assistance’ is favorable which permits the operator to see a repair shop without needing significantly higher actuating forces in order to achieve a sufficient rate of deceleration.

In view of the above, an object of the invention is to provide a low-cost and safe fallback mode for a simple hydraulic booster of the type referred to hereinabove.

According to the invention, this object is achieved by a method in that upon failure of the high-pressure accumulator, the wheel brakes are acted upon by hydraulic pressure of the hydraulic pump according to the sensor system sensing the actuation or according to the pressure sensor.

In an improvement of the method of the invention, it is arranged that upon failure of the pump, hydraulic pressure out of the high-pressure accumulator is applied to the booster chamber according to the sensor system sensing the actuation or according to the pressure sensor.

It is provided that the sensor system consists of two sensors for determining the angle of rotation, the output values of which are compared with one another. In addition, a second pressure sensor is provided to sense the hydraulic pressure that prevails in the master brake cylinder, and a comparison is made between the output values of both pressure sensors.

The object at topic is also achieved according to the invention in that a means is provided which, upon failure of the high-pressure accumulator, applies hydraulic pressure from the hydraulic pump to the wheel brakes according to the sensor system sensing the actuation or according to the pressure sensor.

According to a particularly favorable improvement of the object of the invention, a means is provided which, upon failure of the pump, applies hydraulic pressure from the high-pressure accumulator to the booster chamber according to the sensor system sensing the actuation or according to the pressure sensor.

In this arrangement, the sensor system consists of two sensors for determining the angle of rotation, and a second pressure sensor is provided to sense the hydraulic pressure prevailing in the master brake cylinder.

In an especially advantageous improvement of the object of the invention, an electronic control and regulation unit is provided which comprises two separate control devices, with one sensor for determining the angle of rotation and one pressure sensor being associated with each control device.

Hereinbelow, the invention will be explained in detail by way of an embodiment making reference to the accompanying drawings. In the drawings:

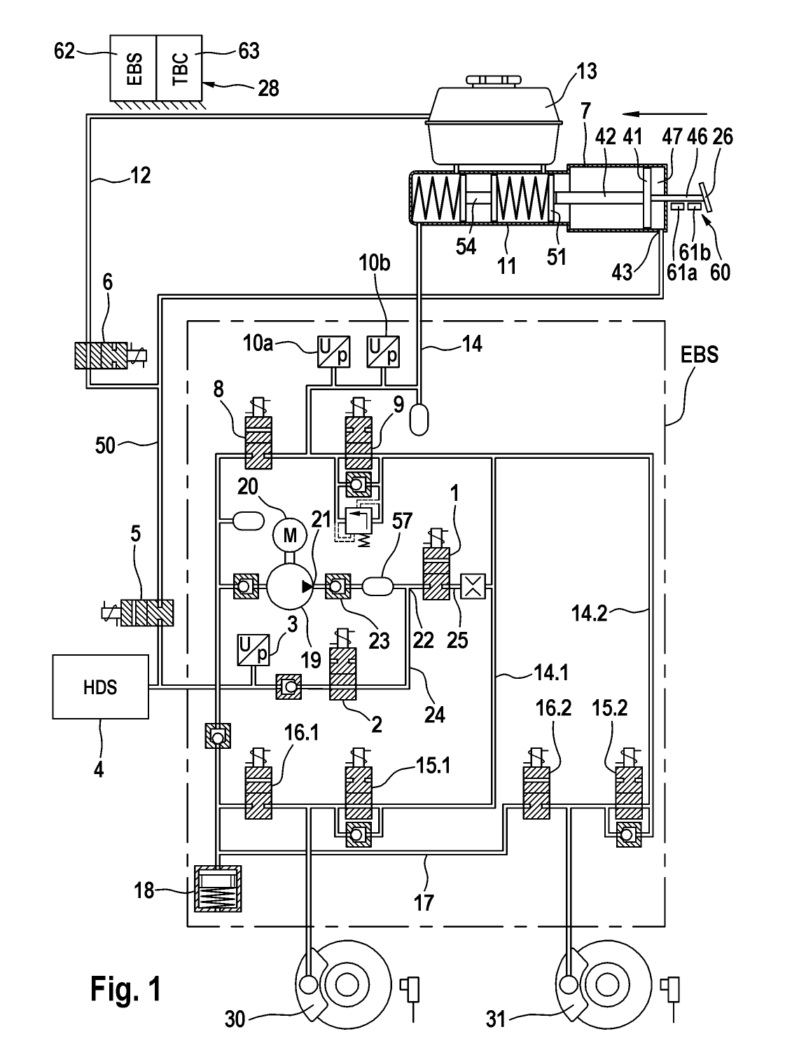

FIG. 1 is a schematic representation of a circuit diagram of a hydraulic vehicle brake system, on which the method of the invention can be implemented, and

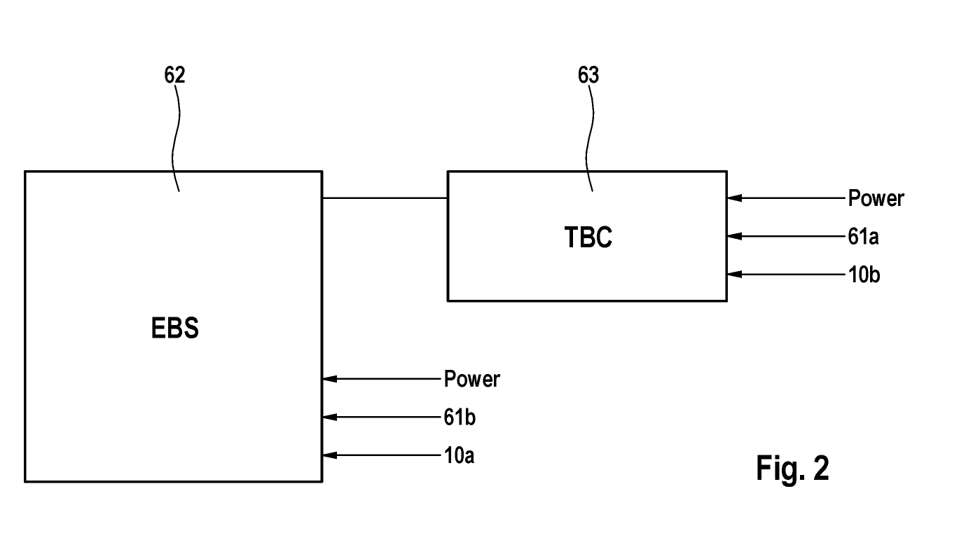

FIG. 2 is a schematic representation of the control and regulation unit of the invention.

According to FIG. 1, the hydraulic vehicle brake system includes a hydraulic booster 7 as a brake pressure generator, which is designed as an extension of the actuating unit 11 with tank 13. The actuating unit 11 is configured as a tandem master cylinder in the present embodiment and hereinbelow will be referred to as TMC in short. Hydraulic booster 7 includes a booster piston 41 which is guided in a booster housing, and a push rod 42 of booster piston 41 is supported on piston 51 of the push-rod circuit of TMC 11. When viewed in the direction of actuation (being shown as an arrow in FIG. 1), the booster piston 41 is preceded by a booster chamber 47 into which a hydraulic port 43 is opening. The displacement travel of the booster piston 41 corresponds to the added strokes of both circuits of TMC 11. Provided on the frontal end of booster 7 is an opening through which the push rod 46 of the brake pedal 26 enters the booster 7. This construction renders an emergency operation of the TMC 11 possible. In a case of disturbance or failure of the hydraulic pressure or in case the booster 7 fails, the operator is able to actuate the piston 41 also directly, i.e. in a mechanical way, by way of the push rod 46. Thus, the system ensures a so-called fail-safe function by means of a direct hydraulic-mechanical ‘push-through’ mode.

The ratio between the surface of booster piston 41 and the surfaces of pistons 51, 54 of the TMC, in connection with the pressure supplied by a high-pressure source, results in the TMC pressure that can be reached by boosting. The pressure demanded by a control or regulation system is varied by the pressure of the high-pressure source.

Preferably, a hydraulic high-pressure accumulator (HPA) 4 is used as a high-pressure source. The high-pressure accumulator 4 is preferably fed by a hydraulic pump 19, 20 with pressurized fluid, i.e. it is being ‘charged’.

FIG. 1 shows a brake circuit (of two brake circuits in total) connected to the actuating unit 11 and acting upon two wheel brakes 30, 31. The second brake circuit for the two other wheel brakes is identical in design and function to the brake circuit shown and, therefore, is not described in detail.

The brake circuits are acted upon by hydraulic pressure of the actuating unit TMC 11 according to FIG. 1. In this case, TMC 11 is fed with hydraulic fluid out of hydraulic supplies of tank 13. TMC 11 is actuated by way of the hydraulic brake booster 7 described hereinabove. The pressure demanded by the respective control or regulation systems of an electronic unit 28 is generated by way of the hydraulic booster 7 and TMC 11. By way of normally open (NO) valves 15.1 and 15.2, the wheel brakes 30, 31 are supplied with pressure directly from TMC cylinder 11 through a line 14, a NO separating valve 9 and subsequent lines 14.1 and 14.2, in which case TMC 11 is actuated by way of the hydraulic booster 7, to which hydraulic pressure out of a pressure source 4, 19, 20 can be applied.

The braking pressure built up before is discharged by way of a return line 17 and normally closed (NC) valves 16.1 and 16.2, alternatively into a low-pressure accumulator 18, or it is returned to TMC 11 by way of a NC change-over valve 8.

High-pressure accumulator 4 is normally charged by opening a valve 2. When the pressure in the high-pressure accumulator falls below a predetermined nominal value, brake fluid is aspirated from TMC 11 by way of the open change-over valve 8 and by means of the pump 19 operated by motor 20. Brake fluid is pumped into the high-pressure accumulator 4 through a non-return valve 23 linking to the pressure side 21 of the pump 19, a damping chamber 57, a line branching 22, and a line 24 into which the valve 2 and a pressure sensor 3 are inserted. As this occurs, motor 20 is actuated until a predetermined nominal pressure is reached. The pressure is measured by pressure sensor 3. When the high-pressure accumulator 4 is filled, valve 5 arranged in a line 50 between high-pressure accumulator 4 and booster 7 is closed. The pressure side of the pump 19 is connected to the wheel brakes 30, 31 also by way of branching 22 and a subsequent line 25 into which a valve 1 is inserted.

When a braking request is detected by the sensor system 60, the valve 5 of preferably analog operation is correspondingly opened in dependence on the displacement travel of the push rod 46 of the brake pedal 24 and/or the actuating speed so that brake fluid can flow from the charged high-pressure accumulator 4 into the chamber 47 arranged behind the booster piston. A pressure sensor 10a monitors pressure development in the booster 7 by way of the pressure that builds up in TMC 11. That means a defined travel is associated with a defined pressure in the TMC and controlled. In this arrangement, the booster piston 41 is moving in front of the push rod 46 of the brake pedal 26 that advances into the booster chamber 47 at an increasing rate, without any contact developing or having to develop. It is favorable to arrange elastic means, in particular a spring, between the push rod 46 and the booster piston 41 in order to achieve an elastical coupling.

When the driver releases the brake pedal, meaning the travel decreases again, the valve 5 will be closed, and a valve 6 that is likewise of preferably analog operation and disposed in a line 12 between the high-pressure accumulator 4 and the tank 13 will be opened by analog control corresponding to the withdrawal of the driver's request, and brake fluid can flow back into the supply tank 13 again. The favorable design of the valve 6 as NO valve renders it possible to actuate the booster in the event of system failure without vacuum developing in the booster 7 (or in the booster chamber 47, respectively) because volume compensation takes place by way of valve 6. With this braking detection, the driver is only required to overcome the additional force which is generated by the pressure already prevailing in the booster 7. This additional force depends only on the surface of the push rod 45 projecting into the booster 7.

When the control of the booster 7 has an autonomous structure, failure of the components, which are enclosed in dash-dot lines and designated by EBS in FIG. 1, would entail the loss of the command variable ‘TMC pressure’, what in turn would have failure of the control of booster 7 as a result. Thus, if the pump 19 or the pump motor 20 is defective and the pressure sensor 10a supplies no output signals, hydraulic pressure out of the high-pressure accumulator 4 is applied to the booster chamber 47 according to the sensor system 60 which detects actuation. If pressure sensor 10a is still available, the booster chamber 47 can be acted upon by hydraulic pressure out of the high-pressure accumulator 4 according to the pressure sensor 10a. This measure allows carrying out still more control operations of the booster 7 with hydraulic brake force assistance until the high-pressure accumulator 4 is emptied. As the pressure sensor 10a is probably not available in the event of failure of the EBS components, a second pressure sensor 10b is provided, according to which pressure out of the high-pressure accumulator 4 is applied to the booster chamber 47. The output signals of the second pressure sensor 10b are sent to a control device 63 for controlling the booster 8, which is isolated from another control device 62 for controlling the EBS components, as will be explained in detail in the following by way of FIG. 2. In the case of a defect of the control device 62 for controlling the EBS components, the previously described operation of booster 7 and the previously described supply of the booster chamber 47 with hydraulic pressure out of the high-pressure accumulator 4, respectively, is safeguarded now as before.

When the controlling of booster 7 fails, that means, when the high-pressure accumulator 4, the sensor system 60, and the control device 63 for the booster control are defective, the wheel brakes 30, 31 are acted upon by hydraulic pressure of the hydraulic pump 19 depending on the pressure sensor 10a. This measure allows carrying out braking operations with hydraulic brake force assistance in the fallback mode. In this case, the sensor system 60 consists of two sensors for determining the angle of rotation 61a and 61b, which are respectively allocated to a control device 62, 63, as will still be described in detail in the following by way of FIG. 2. This means that a defect of the control device 63 for the booster control will not automatically cause complete failure of the sensor system 60, and the wheel brakes 30, 31 can be acted upon by hydraulic pressure of the hydraulic pump 19 according to the sensor 61b for determining the angle of rotation which is not affected by the defect of the control device 63.

As is illustrated in FIG. 2, the control and regulation unit 28 consists of two control devices 62, 63. The output signals of a pressure sensor 10a and a sensor 61b for determining the angle of rotation are sent to the control device 62 for controlling the EBS components. The output signals of a pressure sensor 10b and a sensor 61a for determining the angle of rotation are likewise sent to the other control device 63 for controlling the booster. These measures reliably ensure the operation of the vehicle brake system in the fallback mode during a possible failure of individual components.

During the normal function, the sensors of the fallback mode can additionally be used for plausibilisation. The output values of the two sensors 61a, 61b for determining the angle of rotation are compared for this purpose. The same applies to the output values of the two pressure sensors 10a, 10b, and of course a plausibilisation test is possible between the output values of the sensors 61a, 61b for determining the angle of rotation and the output values of the pressure sensors 10a, 10b.

1-9. (canceled)

10. A method for operating a hydraulic vehicle brake system comprising a brake pressure generator by a brake actuating device and connectable to wheel brakes (30, 31) of the vehicle via a hydraulic line, wherein the brake pressure generator is generally composed of a master brake cylinder (11) and a hydraulic booster (7) connected upstream thereof which includes a booster chamber (47) and a booster piston (41) arranged therein, which latter is operatively connected to a master brake cylinder piston by way of an actuating element (42) in the direction of force output and which, for brake force boosting purposes, can be acted upon by a hydraulic pressure of a high-pressure accumulator (4) that is chargeable by a hydraulic pump (19, 20) according to a sensor system (60) which detects actuation or senses the hydraulic pressure via a pressure sensor (10a) that prevails in the master brake cylinder (11), the method comprising:
upon failure of the high-pressure accumulator (4), the wheel brakes (30, 31) are acted upon by hydraulic pressure of the hydraulic pump (19, 20) according to the sensor system (60) which detects actuation or senses pressure.

11. The method as claimed in claim 10, wherein upon failure of the pump (19, 20), hydraulic pressure out of the high-pressure accumulator (4) is applied to the booster chamber (47) according to the sensor system (60) which detects actuation or senses pressure.

12. The method as claimed in claim 10, wherein the sensor system (60) consists of two sensors (61a, 61b) for determining the angle of rotation, the output values of which are compared with one another.

13. The method as claimed in claim 10, wherein a pressure sensor (10b) is provided to sense the hydraulic pressure that prevails in the master brake cylinder (11), and in that a comparison is made between the output values of both pressure sensors (10a, 10b).

14. A hydraulic vehicle brake system comprising:
a brake pressure generator having a master brake cylinder (11) and a hydraulic booster (7) connected upstream thereof which includes a booster chamber (47) and a booster piston (41) arranged therein;
a brake actuation device, wherein the brake pressure generator is operable by the brake actuating device and being connectable to wheel brakes (30, 31) of the vehicle by way of a hydraulic line which latter is operatively connected to a master brake cylinder piston by way of an actuating element (42) in the direction of force output and which, for brake force boosting purposes, can be acted upon by a hydraulic pressure of a high-pressure accumulator (4) that is chargeable by a hydraulic pump (19, 20) according to a sensor system (60) which detects actuation and/or according to a pressure sensor (10a) sensing the hydraulic pressure that prevails in the master brake cylinder (11); and
a device is provided which, upon failure of the high-pressure accumulator (4), applies hydraulic pressure of the hydraulic pump (19, 20) to the wheel brakes (30, 31) according to the sensor system (60) which detects actuation or according to the pressure sensor (10a).

15. The hydraulic vehicle brake system as claimed in claim 14, wherein a device is provided which, upon failure of the pump (19, 20), applies hydraulic pressure out of the high-pressure accumulator (4) to the booster chamber (47) according to the sensor system (60) which detects actuation or according to the pressure sensor (10a).

16. The hydraulic vehicle brake system as claimed in claim 14, wherein the sensor system (60) consists of two sensors (60a, 60b) for determining the angle of rotation.

17. The hydraulic vehicle brake system as claimed in claim 16, wherein a second pressure sensor (10b) is provided to sense the hydraulic pressure that prevails in the master brake cylinder (11).

18. The hydraulic vehicle brake system as claimed in claim 17, wherein an electronic control unit (28) is provided having two separate control devices (62, 63), with one sensor (61a, 61b) for determining the angle of rotation and one pressure sensor (10a, 10b) being associated with each control device (62, 63).
